(19) United States
(12) Patent Application Publication
(10) Pub. No.: US 2017/0060259 A1
(43) Pub. Date: Mar. 2, 2017

(54) INFORMATION PROCESSING METHOD AND ELECTRONIC DEVICE

(71) Applicants: Beijing Lenovo Software Ltd., Beijing (CN); Lenovo (Beijing) Limited, Beijing (CN)

(72) Inventors: Liangyin Yang, Beijing (CN); Xuguo Liu, Beijing (CN); Weixian Guo, Beijing (CN)

(21) Appl. No.: 14/978,099

(22) Filed: Dec. 22, 2015

(30) Foreign Application Priority Data
Aug. 24, 2015 (CN) 201510524207.3

(51) Int. Cl. G06F 3/02; G06K 9/00; H04L 9/32

(52) U.S. Cl. CPC G06F 3/0227; H04L 9/3231; G06K 9/0002; G06K 9/00087

(57) ABSTRACT

An embodiment of the present disclosure discloses an information processing method and an electronic device. The method comprises: a fingerprint service entering a stage of verifying the fingerprint, when an electronic device enters a stage of inputting a fingerprint, so that a fingerprint texture collected by a collecting region in an input surface of a key of the electronic device is capable of being verified; the fingerprint service setting a flag bit; a keystroke service obtaining the flag bit when the key is pressed; disabling a corresponding operation instruction by the keystroke service in response to the pressing of the key based on the flag bit; collecting the fingerprint texture by the collection region in the input surface of the key when the key is pressed, and the fingerprint service verifying the fingerprint based on the fingerprint texture.

### CROSS-REFERENCE TO RELATED APPLICATION(S)

This application claims priority to the Chinese Patent Application No. 201510524207.3, filed on Aug. 24, 2015, entitled “Information Processing Method and Electronic Device” which is incorporated herein by reference in its entirety.

### TECHNICAL FIELD

The present disclosure relates to the information field, especially to an information processing method and an electronic device.

### BACKGROUND

With developments of information technique and electronic technique, one key in an electronic device such as a mobile phone, a tablet computer and a wearable device and the like normally corresponds to two functions. For example, a main control key in some mobile phones not only implements a function of returning back to a main menu for the main control key, but also is used to operations of collecting fingerprint and so on. However, at this moment, the operation of collecting fingerprint relates to pressing of user's finger and the operation of returning back to the main menu also needs to detect pressing of the user's finger. There is a conflict for the electronic device utilizing the pressing of the fingerprint for collecting the fingerprint or returning to the main menu, which would lead to an erroneous response. It is obvious that intelligence of the electronic device is not high enough.

### SUMMARY

Thus, an embodiment of the present disclosure provides an information processing method and an electronic device so as to enhance the intelligence of the electronic device.

In order to obtain the objective as mentioned above, a technical solution of the present disclosure is implemented as follows.

A first aspect of the embodiment of the present disclosure provides an information processing method comprising: a fingerprint service entering a stage of verifying the fingerprint, when an electronic device enters a stage of inputting a fingerprint, so that a fingerprint texture, which collected by a collecting region in an input surface of a key of the electronic device, is capable of being verified; the fingerprint service setting a flag bit; a keystroke service obtaining the flag bit when the key is pressed; disabling, based on the flag bit, a corresponding operation instruction by the keystroke service in response to the pressing of the key; collecting the fingerprint texture by the collection region in the input surface of the key when the key is pressed, and the fingerprint service verifying the fingerprint based on the fingerprint texture.

On the basis of the technical solution as mentioned above, the fingerprint service removes the flag bit when the stage of inputting a fingerprint is ended, so that the key directly responds to the operation instruction corresponding to the pressing of the key.

On the basis of the technical solution as mentioned above, the step of the electronic device entering a stage of inputting a fingerprint may comprises: notifying the fingerprint service of verify the fingerprint when a first application or a first progress required to verify the fingerprint generates a verification requirement; and the fingerprint service entering the stage of verifying the fingerprint based on the notifying, wherein the stage of verifying the fingerprint comprises the stage of inputting the fingerprint.

On the basis of the technical solution as mentioned above, the method further comprises: generating an interface for indicating to input the fingerprint and displaying the interface on a display screen of the electronic device to prompt a user of the electronic device to input the fingerprint, when the first application or the first progress required to verify the fingerprint generates the verification requirement; or generating the interface for indicating to input the fingerprint the fingerprint service, and displaying the interface on the display screen of the electronic device to prompt a user of the electronic device to input the fingerprint.

On the basis of the technical solution as mentioned above, the method further comprises: generating, by the keystroke service, an indication information for indicating the user whether to leave the stage of verifying fingerprint, When the keystroke service obtains the flag bit; obtaining, by the keystroke service, a first confirmation instruction for representing that the user selects to leave the stage of verifying the fingerprint; removing the flag bit by the keystroke service, in response to the first confirmation instruction so that the key directly responds to the operation instruction corresponding to the pressing of the key.

A second aspect of the embodiment of the present disclosure provides an electronic device comprising: a key configured to detect a pressing of the key, wherein a collection region is provided in an input surface of the key, and the collection region is configured to collect a fingerprint texture; a processor configured to run a fingerprint service and a keystroke service; when the electronic device enters a stage of inputting a fingerprint, the fingerprint service is at a stage of verifying the fingerprint so that a fingerprint texture collected by the collecting region is capable of being verified; the fingerprint service sets a flag bit; the keystroke service obtains the flag bit when the key is pressed, and disables, based on the flag bit, a corresponding operation instruction in response to the pressing of the key; when the key is pressed, the fingerprint texture is collected by the collection region; and the fingerprint service is further configured to verify the fingerprint based on the fingerprint texture.

On the basis of the technical solution as mentioned above, the fingerprint service removes the flag bit when the stage of inputting a fingerprint is ended, so that the key directly responds to the operation instruction corresponding to the pressing of the key.

On the basis of the technical solution as mentioned above, the processor is further configured to run a first application or a first progress required to verify the fingerprint; the first application or the first progress generates the requirement of verifying and notifies the fingerprint service to verify the fingerprint; and the fingerprint service enters the stage of verifying the fingerprint based on the notifying, wherein the stage of verifying the fingerprint comprises the stage of tying in the fingerprint.

On the basis of the technical solution as mentioned above, the first application or the first progress is further configured to generate an interface for indicating to input the fingerprint when a requirement of verifying the fingerprint is generated or the fingerprint service is further configured to generate an interface for indicating to input the fingerprint.

The electronic device may further comprise a display screen for displaying the interface for indicating to input the fingerprint so as to prompt the user of the electronic device to input the fingerprint.

On the basis of the technical solution as mentioned above, the keystroke service is configured to generate an indication information for indicating the user whether to leave the stage of verifying fingerprint when the flag bit is obtained; the keystroke service obtains a first confirmation instruction for representing that the user selects to leave the stage of verifying the fingerprint; the keystroke service removes the flag bit in response to the first confirmation instruction so that when the key is pressed, the key directly responds to the operation instruction corresponding to the pressing of the key.

The information processing method and the electronic device according to embodiments of the present disclosure may collect fingerprint textures by the collection region in the input surface of the key, and may input the fingerprint and verify the fingerprint during a stage of verifying the fingerprint by setting the flag bit so as to disable the operation instruction corresponding to the pressing. The present disclosure may precisely responding to a processing of inputting and verifying the fingerprint, decrease a possibility of erroneous response of the electronic device and enhance intelligence of the electronic device and satisfaction of the user.

### BRIEF DESCRIPTION OF THE DRAWINGS

FIG. 1 is a schematic view of a flowchart of the first type of information processing method provided by an embodiment of the present disclosure;

FIG. 2 is a schematic view of a flowchart of the second type of information processing method provided by an embodiment of the present disclosure;

FIG. 3 is a schematic view of a flowchart in the stage of inputting the fingerprint provided by an embodiment of the present disclosure;

FIG. 4 is a schematic view of a partial flowchart of the information processing method provided by an embodiment of the present disclosure;

FIG. 5 is a schematic view of a configuration of the first type of electronic device provided by an embodiment of the present disclosure;

FIG. 6 is a schematic view of a configuration of the second type of electronic device provided by an embodiment of the present disclosure;

FIG. 7 is a schematic view of a flowchart for entering the interface for inputting the fingerprint provided by an embodiment of the present disclosure;

FIG. 8 is a schematic view of a flowchart for exiting the interface for the fingerprint provided by an embodiment of the present disclosure; and

FIG. 9 is a schematic view of a flowchart of the third type of information processing method provided by an embodiment of the present disclosure.

### DETAILED DESCRIPTION

The technical solution of the present disclosure will be further illustrated in detail in conjunction with accompany figures and particular embodiments of the present disclosure.

### The First Method Embodiment

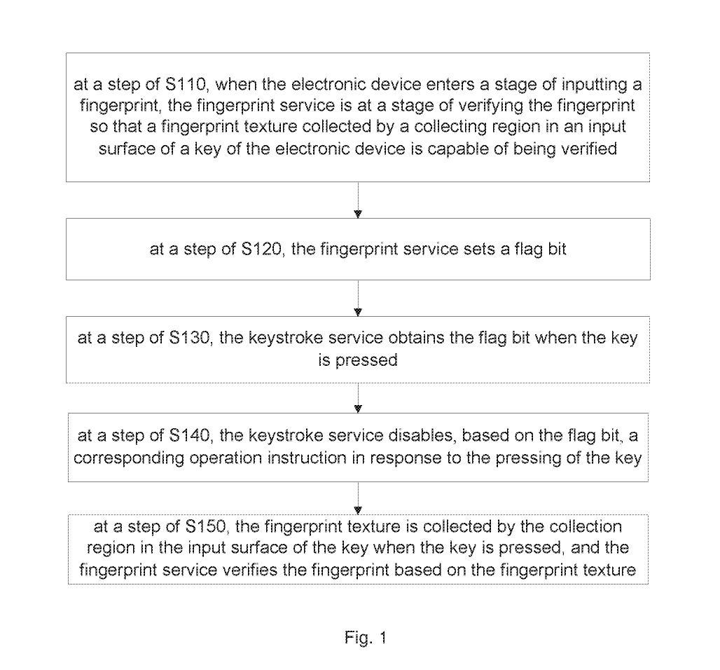

As shown in FIG. 1, the present embodiment provides an information processing method comprising: at a step of S110, when the electronic device enters a stage of inputting a fingerprint, the fingerprint service is at a stage of verifying the fingerprint so that a fingerprint texture collected by a collecting region in an input surface of a key of the electronic device is capable of being verified; at a step of S120, the fingerprint service sets a flag bit; at a step of S130, the keystroke service obtains the flag bit when the key is pressed; at a step of S140, the keystroke service disables, based on the flag bit, a corresponding operation instruction in response to the pressing of the key; at a step of S150, the fingerprint texture is collected by the collection region in the input surface of the key when the key is pressed, and the fingerprint service verifies the fingerprint based on the fingerprint texture.

The information processing method of the present embodiment may be applied to an electronic device such as a mobile phone, a tablet computer or a wearable device and so on. The electronic device may be provided with a key capable of detecting pressing and a collection region for collecting the fingerprint texture is provided in the input surface of the key. The collection region may comprise a means for collecting the fingerprint texture such as a fingerprint collector or a scanner.

The electronic device runs a fingerprint service and a keystroke service. The fingerprint service is configured to implement information processing during collecting and verifying the fingerprint; and the keystroke service is configured to implement an operation instruction corresponding to the pressing.

In the present embodiment, at the step of S110, when the electronic device enters a stage of inputting the fingerprint, the fingerprint service is at a stage of verifying the fingerprint during which the fingerprint service has accomplished a preparing operation for verifying the fingerprint, may receive the fingerprint texture collected by the collection region, and may implement the processing operations such as fingerprint matching and identification, so as to verify whether the collected fingerprint texture is the fingerprint texture satisfying a verification condition.

At the step of S120, the fingerprint service is at a stage of verifying the fingerprint. In order to avoid a misoperation in which during the process of collecting the fingerprint texture, the user's finger presses the key which leads to that the electronic device detects the operation of pressing and the electronic device believes by mistake that the operation instruction corresponding to the pressing, or in order to avoid an issue of response conflict with the collecting of the fingerprint texture, the fingerprint service will set a flag bit which represents the electronic device is at a stage of verifying the fingerprint. The setting of the flag bit may be convenient for the pressing service to determine how to process when the key detects the pressing.

At the step of S130, when the key detects the pressing, the keystroke service will read the flag bit. The flag bit may be provided in a specified storage position such as a specified register and the like. If the flag bit read from the specified storage position is not empty or represents that it is the flag information at the stage of verifying the fingerprint, it is selected that it at the stage of verifying the fingerprint currently. At the step of S130, if the keystroke service reads out the corresponding flag bit, the disabling response of the operation instruction corresponding to the pressing may be implemented by shielding the operation instruction corresponding to the pressing detected by the key. Thus, the erroneous operation may be avoided so as to enhance an accuracy of the response of the electronic device to the user's input.

At the step of S140, the operation instruction corresponding to the pressing of the key may be any operation instructions predefined in advance. For example, the key may be a confirm key, so the operation instruction may comprises an operation instruction of “confirm”. The key may be a return key; the operation instruction may comprise an operation instruction of “return”. The key may be a home key, so the operation instruction may comprise an operation for returning to the main interface which may comprise a desktop of the electronic device. The key may be a power key and the like, so the power key may be configured to control switching on/off of the electronic device. The key may be a direction key which comprises an upwards direction key and a downwards direction key. The upwards direction key may be used for operation instructions for increasing the volume and/or controlling the up-scrolling of items. The downwards direction key may be used for operation instructions for decreasing the volume and/or controlling the down-scrolling of items.

At the step of S150, when the key is pressed, the fingerprint texture is collected by the collection region in the input surface of the key and the fingerprint service verifies the fingerprint after the fingerprint texture is collected.

Herein, the process of verifying the fingerprint may comprise matching of the fingerprint. For example, the collected fingerprint text is compared with the previously stored fingerprint texture so as to verify whether the currently collected fingerprint is the previously stored fingerprint and to form a verifying result. The process of verifying the fingerprint may further comprise steps of identifying the fingerprint texture, extracting a texture feature of the fingerprint texture, determining whether the texture feature is that of a specified fingerprint and thereby forming the verifying result.

It is definite that in the information processing method of the embodiment of the present disclosure, the collection region is provided on the input surface of the key to collect the fingerprint texture. The key may be further configured to respond to the operation corresponding the pressing. Thus, it is definite that the key combines operation instructions of verifying the fingerprint and the pressing, so it is not necessary to separately provide the keys and regions for collecting the fingerprint texture on the surface of the electronic device, reducing a volume of the electronic device. In order to avoid the misoperation, the flag bit is introduced so that the electronic device may determine whether to respond the process of collecting the fingerprint or to respond to the operation instruction corresponding to the pressing by setting and acquiring the flag bit. Thus, the present method decreases a possibility of erroneous response of the electronic device and enhances intelligence of the electronic device and satisfaction of the user.

### The Second Method Embodiment

As shown in FIG. 1, the present embodiment provides an information processing method comprising: at a step of S110, when the electronic device enters a stage of inputting a fingerprint, the fingerprint service is at a stage of verifying the fingerprint so that a fingerprint texture collected by a collecting region in an input surface of a key of the electronic device is capable of being verified; at a step of S120, the fingerprint service sets a flag bit; at a step of S130, when the key is pressed, the keystroke service obtains the flag bit; at a step of S140, the keystroke service disables a corresponding operation instruction in response to the pressing of the key based on the flag bit; at a step of S150, when the key is pressed, the fingerprint texture is collected by the collection region in the input surface of the key and the fingerprint service verifies the fingerprint based on the fingerprint texture.

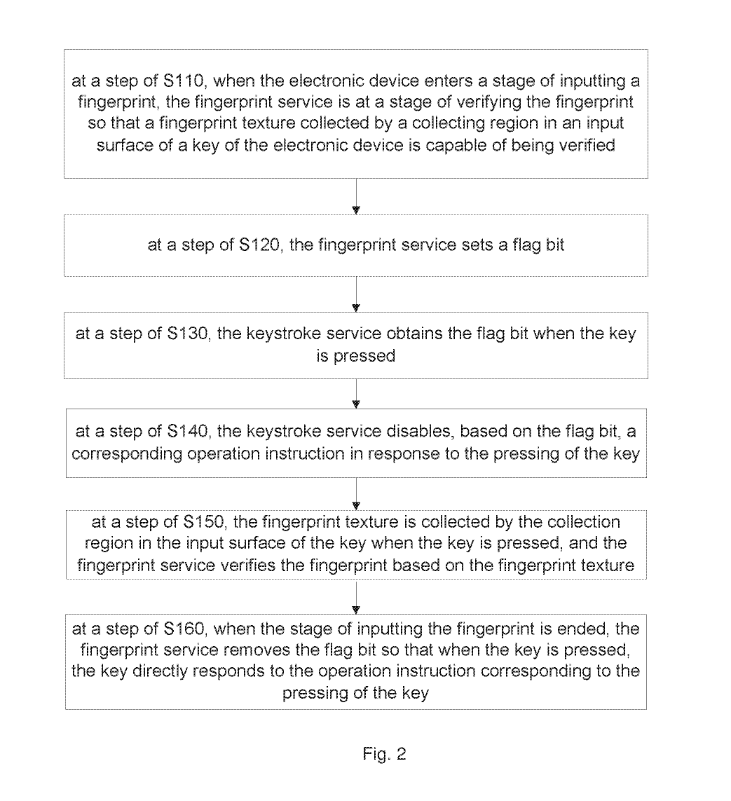

As shown in FIG. 2, the method may further comprise: at a step of S160, when the stage of inputting the fingerprint is ended, the fingerprint service removes the flag bit so that when the key is pressed, the key directly responds to the operation instruction corresponding to the pressing of the key. The ending of inputting the fingerprint may be a moment at which a specified times of collecting the fingerprint is accomplished, so it is determined that the stage of inputting the fingerprint is ended. A numerical value of the specified maybe one or more, and its particular value depends on a requirement of the fingerprint verification. For example, if a user pays off in Internet by utilizing Alipay, fingerprint verification is required to enter the Alipay payment interface; and a further fingerprint verification is also required to confirm the payment when a particular currency amount for the payment is entered. It is definite that such a process relates to collections of two fingerprints and the two fingerprints may be a collection of the same fingerprint or a collection of different fingerprints. For example, if a collection of the fingerprint for the user's index finger is required for the payment interface, a collection of the fingerprint for the user's ring finger may be used for confirmation of the payment.

When the stage of inputting the fingerprint is ended, it is indicated that it does not need to collect the fingerprint texture. In order to implement the operation instruction corresponding to the pressing of the key successfully, in the present embodiment, the fingerprint service will remove the flag bit. Thus, the keystroke service can't read out the flag bit, so the keystroke service will not disable responding to the operation instruction corresponding to detection of the pressing.

When the flag bit is removed, the fingerprint service will shield the process of verifying the fingerprint texture. The process of verifying the fingerprint texture may comprise at least two stages of inputting the fingerprint and verifying the fingerprint. After the flag bit is removed, the collection region may shield verifying of the fingerprint texture by not collecting the fingerprint texture, and may not verify the fingerprint collected after the flag bit is removed when the fingerprint service receives the inputting of the fingerprint in the collection region, which is another means for shielding verifying of the fingerprint texture.

By utilizing the process as mentioned above, it may be nicely determined whether it responds to the collection and verification of the fingerprint or responds to the operation instruction corresponding to the pressing. Thus, a possibility of misoperation or conflict between two operations can be decreased.

### The Third Method Embodiment

As shown in FIG. 1, the present embodiment provides an information processing method comprising: at a step of S110, when the electronic device enters a stage of inputting a fingerprint, the fingerprint service is at a stage of verifying the fingerprint so that a fingerprint texture collected by a collecting region in an input surface of a key of the electronic device is capable of being verified; at a step of S120, the fingerprint service sets a flag bit; at a step of S130, when the key is pressed, the keystroke service obtains the flag bit; at a step of S140, the keystroke service disables a corresponding operation instruction in response to the pressing of the key based on the flag bit; at a step of S150, when the key is pressed, the fingerprint texture is collected by the collection region in the input surface of the key and the fingerprint service verifies the fingerprint based on the fingerprint texture.

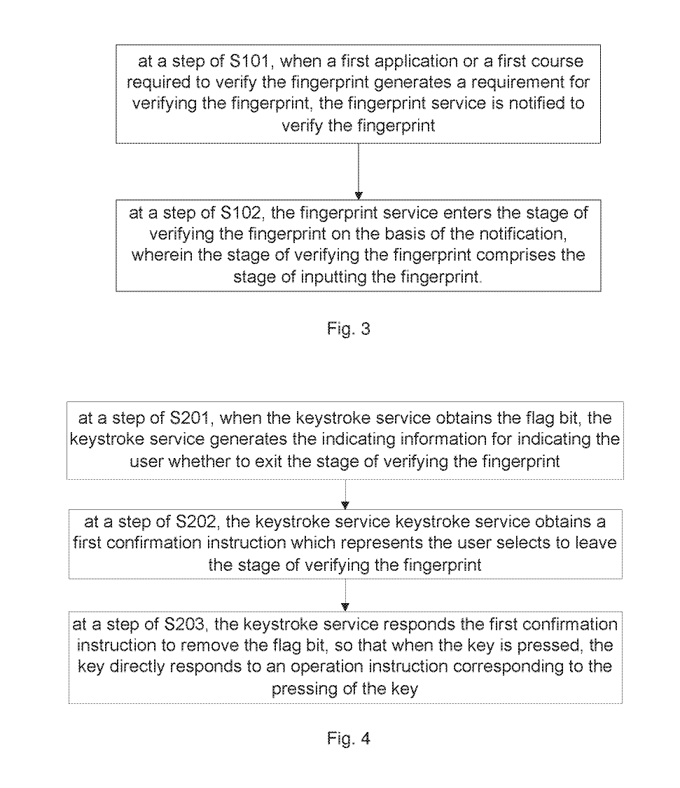

As shown in FIG. 3, the step of the electronic device entering the stage of inputting the finger texture comprises: at a step of S101, when a first application or a first course required to verify the fingerprint generates a requirement for verifying the fingerprint, the fingerprint service is notified to verify the fingerprint; at a step of S102, the fingerprint service enters the stage of verifying the fingerprint on the basis of the notification, wherein the stage of verifying the fingerprint comprises the stage of inputting the fingerprint.

The first application and the first course of the present embodiment generally refer to applications and courses required to verify the fingerprint and do not in particular refer to a certain application or a certain course.

The first application of the present embodiment may comprise various applications required to verify the fingerprint, such as an application related to a payment, an application related to processing of private information and the like.

For example, the application related to a payment may be Alipay, Tenpay, Wechat Payment and application for purchasing and paying. For example, the application for purchasing and paying may be Tmall, JD, Vipshop or the like.

The private information may comprise information such as personal privacy, a business email, diary, financial record, important communication records and the like. The application related to processing of private information may comprise a diary application, an account application, an email application, a schedule application and the like.

The first course may be a course related to safety in utilization of the electronic device or the course for safety of information storage in the electronic device. In particular, the first course may comprise an unlock screen course of the electronic device, a startup course of the electronic device and a safety verification course for specified operation. The unlock screen course may correspond to a course for entering a desktop of the electronic device. Before entering the desktop, the electronic device is at a stage of locking the screen, so it is required to collect and verify the fingerprint texture so as to unlock the screen and to verify the safety.

At the step of S101, when the electronic device detects that a requirement for verification is generated, a notification is automatically generated to verify the fingerprint texture. At the step of S102, the fingerprint service will receive the notification and enter the stage of verifying the fingerprint on the basis of the notification. Thus, it will successful to input and verify the fingerprint and to avoid the misoperation of responding to the operation corresponding to the pressing.

The stage of inputting the fingerprint is a sub stage of the stage of verifying the fingerprint, and generally is the first sub stage for verifying the fingerprint. During the stage of inputting the fingerprint, the collection region will collect the user's fingerprint texture. After the fingerprint texture is collected, the fingerprint service may utilize the stage of verifying the fingerprint texture in the stage of verifying the fingerprint to verify the fingerprint texture.

The electronic device of the embodiment of the present disclosure automatically enters the stage of verifying the fingerprint when the requirement for verifying the fingerprint is detected, which definitely enhance intelligence of the electronic device and satisfaction of the user.

The method of the present embodiment may further comprises a step of S160 as shown in FIG. 2, similarly when the stage of inputting the fingerprint is ended, the fingerprint service automatically removes the flag bit, so that the electronic device may duly and precisely respond the operation instruction corresponding to the pressing on the key. Thus, by utilizing the information processing method of the present embodiment, when there is a requirement for verifying the fingerprint, the electronic device may duly enter the stage of verifying the fingerprint to respond the requirement for verifying the fingerprint; and by removing the flag bit at the step of S160, the electronic device may precisely respond to the operation instruction corresponding to the pressing.

### The Fourth Method Embodiment

As shown in FIG. 1, the present embodiment provides an information processing method comprising: at a step of S110, when the electronic device enters a stage of inputting a fingerprint, the fingerprint service is at a stage of verifying the fingerprint so that a fingerprint texture collected by a collecting region in an input surface of a key of the electronic device is capable of being verified; at a step of S120, the fingerprint service sets a flag bit; at a step of S130, when the key is pressed, the keystroke service obtains the flag bit; at a step of S140, the keystroke service disables a corresponding operation instruction in response to the pressing of the key based on the flag bit; at a step of S150, when the key is pressed, the fingerprint texture is collected by the collection region in the input surface of the key and the fingerprint service verifies the fingerprint based on the fingerprint texture.

As shown in FIG. 3, the step of the electronic device entering the stage of inputting the finger texture comprises: at a step of S101, when a first application or a first course required to verify the fingerprint generates a requirement for verifying the fingerprint, the fingerprint service is notified to verify the fingerprint; at a step of S102, the fingerprint service enters the stage of verifying the fingerprint on the basis of the notification, wherein the stage of verifying the fingerprint comprises the stage of inputting the fingerprint.

The method of the present embodiment further comprises a step of generating and displaying an interface for indicating to input the fingerprint, when or after the electronic device enters the stage of verifying the fingerprint.

In the present embodiment, the displaying of the interface for indicating to input the fingerprint has two functions as follows.

The first option: by displaying the interface for indicating to input the fingerprint, the user is indicated to duly input the fingerprint so as to avoid that the user forget inputting the fingerprint or the user does not know to input the fingerprint, which is falsely deemed that the electronic device halts and the electronic device does not respond. Thus, it may enhance efficiency of information communication between the electronic device and the user, and may decrease the possibility of a low user's satisfaction.

The second option: by displaying the interface for indicating to input the fingerprint, the user is notified that the electronic device has entered a stage of verifying the fingerprint so the electronic device may implement the processing such as inputting the fingerprint, verifying the fingerprint and the like. Thus, when the user gets a sight of the interface for indicating to input the fingerprint, the user may know that the electronic device has entered the stage of verifying the fingerprint and may input the fingerprint, which avoids the user can't determine whether the electronic device is ready to collect the user's fingerprint texture. Thus, by displaying the interface for indicating, the intelligence of the electronic device is enhanced, a better information communication with the user is implemented and the user's satisfaction is also enhanced.

The interface for indicating to input the fingerprint may comprise information for indicating to input the fingerprint. The information for indicating to input the fingerprint may comprise indicating text information, indicating image information and/or indicating voice or video information and the like. In particular, the interface for indicating may comprise an indicating dialog box which displays system information carrying the indication information as mentioned above.

In the present embodiment, the interface for indicating to input the fingerprint may be provided with a corresponding indicating audio. After the interface for indicating to input the fingerprint is entered, the electronic device outputs an indicating ring outwards so as to indicate the user to view a current displaying of the electronic device, or utilizes the indicating ring to indicate the user that the electronic device has entered the stage of verifying the fingerprint.

The step of the electronic device entering the stage of verifying the fingerprint and the step of generating the interface for indicating to input the fingerprint may be implemented simultaneously. Thus, a display screen of the electronic device may display the interface for indicating to input the fingerprint as quickly as possible. The steps of generating and displaying the interface for inputting the fingerprint may be implemented after the electronic device enters the stage of verifying the fingerprint.

There are various means for generating and displaying the interface for indicating to input the fingerprint, two possible ones of which are provided as follows (in a particular implementation, any means may be selected to implement the step of generating and displaying the interface for indicating to input the fingerprint).

The first option: when the first application or the first course required to verify the fingerprint generates a requirement for verifying the fingerprint, the interface for indicating to input the fingerprint is generated and displayed on a screen of the electronic device to indicate the user of the electronic device to input the fingerprint.

The second option: the fingerprint service generates the interface for indicating to input the fingerprint to be displayed on the screen of the electronic device to indicate the user of the electronic device to input the fingerprint.

In the first option, the subject for generating the interface for indicating to input the fingerprint may be the first application or the first course required to verify the fingerprint. In the second option, the subject for generating the interface for indicating to input the fingerprint may be the fingerprint service.

The two means for generating the interface for indicating to input the fingerprint as mentioned above have a feature to be implemented simply. In a particular implementation, the subject for generating the interface for indicating to input the fingerprint may be a specific course for generating the interface for indicating to input the fingerprint, and is not limited to the first application, the first course or the fingerprint service. Since the fingerprint service is closely related to the fingerprint verification with respect to the first application and the second application, if the fingerprint service is used to generate the interface for indicating to input the fingerprint, the information interaction between the applications and/or courses may be reduced and the processing for generating the interface will be simpler.

The information processing method of the present embodiment is further modified based on the fourth method embodiment, and in a particular implementation, it may comprise or may not comprise the step of S160 as shown in FIG. 2. The particular implementation of the step S160 is shown in the second method embodiment and here is omitted for brevity.

### The Fifth Method Embodiment

As shown in FIG. 1, the present embodiment provides an information processing method comprising: at a step of S110, when the electronic device enters a stage of inputting a fingerprint, the fingerprint service is at a stage of verifying the fingerprint so that a fingerprint texture collected by a collecting region in an input surface of a key of the electronic device is capable of being verified; at a step of S120, the fingerprint service sets a flag bit; at a step of S130, when the key is pressed, the keystroke service obtains the flag bit; at a step of S140, the keystroke service disables a corresponding operation instruction in response to the pressing of the key based on the flag bit; at a step of S150, when the key is pressed, the fingerprint texture is collected by the collection region in the input surface of the key and the fingerprint service verifies the fingerprint based on the fingerprint texture.

As shown in FIG. 3, the step of the electronic device entering the stage of inputting the finger texture comprises: at a step of S101, when a first application or a first course required to verify the fingerprint generates a requirement for verifying the fingerprint, the fingerprint service is notified to verify the fingerprint; at a step of S102, the fingerprint service enters the stage of verifying the fingerprint on the basis of the notification, wherein the stage of verifying the fingerprint comprises the stage of inputting the fingerprint.

In the embodiment of the present embodiment, the method may further comprises steps of: generating and outputting an indicating information about whether it is maintained in a stage of verifying the fingerprint; receiving a reply instruction formed on the basis of the indicating information; and maintaining in the stage of verifying the fingerprint or exiting the stage of verifying the fingerprint on the basis of the reply instruction.

In particular, an inquiry dialog box is generated. The dialog box comprises content about whether the electronic device to exit the stage of verifying the fingerprint. If the reply instruction provided by the user is “yes”, the electronic device exits the stage of verifying the fingerprint; otherwise, the electronic device is maintained at the stage of verifying the fingerprint. If user's false triggering leads to that the electronic device enters the stage of verifying the fingerprint, the information processing method of the present embodiment may be used to exit the stage of verifying the fingerprint so that the electronic device may be recovered to respond to the operation instruction corresponding to the detected pressing of the key. Thus, the intelligence and user's satisfaction of the electronic device may be further enhanced.

There are various means for generating and outputting the indicating information, three alternative ones of which are provided as follows.

The first option: as shown in FIG. 4, the means for generating and outputting the indicating information may comprise: at a step of S201, when the keystroke service obtains the flag bit, the keystroke service generates the indicating information for indicating the user whether to exit the stage of verifying the fingerprint; at a step of S202, the keystroke service keystroke service obtains a first confirmation instruction which represents the user selects to leave the stage of verifying the fingerprint; at a step of S203, the keystroke service responds the first confirmation instruction to remove the flag bit, so that when the key is pressed, the key directly responds to an operation instruction corresponding to the pressing of the key.

Herein, the flag bit represents that the electronic device currently is at the step of verifying the fingerprint, so that keystroke service needs to disable responding to the operation instruction corresponding to the pressing. In order to avoid the misoperation caused by the false triggering, the keystroke service generates the indicating information to indicate, which may solve an issue of the false triggering as mentioned above. The first confirmation instruction may be any one of the reply instruction as mentioned above.

The second option: the means for generating and outputting the indicating information may comprise: the keystroke service generates the indicating information for indicating the user whether to exit the stage of verifying the fingerprint; the indicating information is displayed; a second confirmation instruction which represents the user selects to leave the stage of verifying the fingerprint is obtained on the basis of the indicating information; the fingerprint service does not set the flag bit or removes the set flag bit and exits the stage of verifying the fingerprint.

The third option: the method may further comprise that the interface for indicating to input the fingerprint is generated when the first application or the first course requires to verify the fingerprint, and the interface is displayed on the screen of the electronic device to indicate the user of the electronic device to input the fingerprint; or the interface for indicating to input the fingerprint is generated by the fingerprint service and is displayed on the screen of the electronic device to indicate the user of the electronic device to input the fingerprint. The relevant description about the interface for indicating to input the fingerprint is illustrated in the above mentioned embodiment and here is omitted for brevity.

When the keystroke service obtains the flag bit, the keystroke service generates the indicating information to indicate the user whether to leave the interface for inputting the fingerprint; the keystroke service obtains a third confirmation instruction which represents that the user selects to leave the interface for inputting the fingerprint; the keystroke service responds to the third confirmation instruction to remove the flag bit so that the key directly responds the operation instruction corresponding to the pressing of the key when the key is pressed.

In the present option, the indicating information is generally displayed in the interface for indicating to input the fingerprint. If the keystroke service obtains the third instruction, the keystroke service will remove the flag bit so as to recover the operation instruction corresponding to the detected pressing of the key.

The third instruction may be one of the reply instructions as mentioned above.

In a particular implementation, the subject for generating the indicating information may be the fingerprint service. If the indication information generated on the basis of the fingerprint service and detected by the electronic device is the reply instruction for the indicating information to select to leave the interface for inputting the fingerprint, the electronic device selects to leave the interface and the fingerprint service does not continue setting or removing the flag bit to exit the stage of verifying the fingerprint.

The present embodiment provides an information processing method, which facilitate the user to control whether the fingerprint service is at the stage of verifying the fingerprint as desired according to the indicating information. Such a method improves a controllability of the user on the electronic device so as to facilitate the user to indicate whether the electronic device is at the stage of verifying the fingerprint by user's inputting and enhance the user's satisfaction.

### The First Device Embodiment

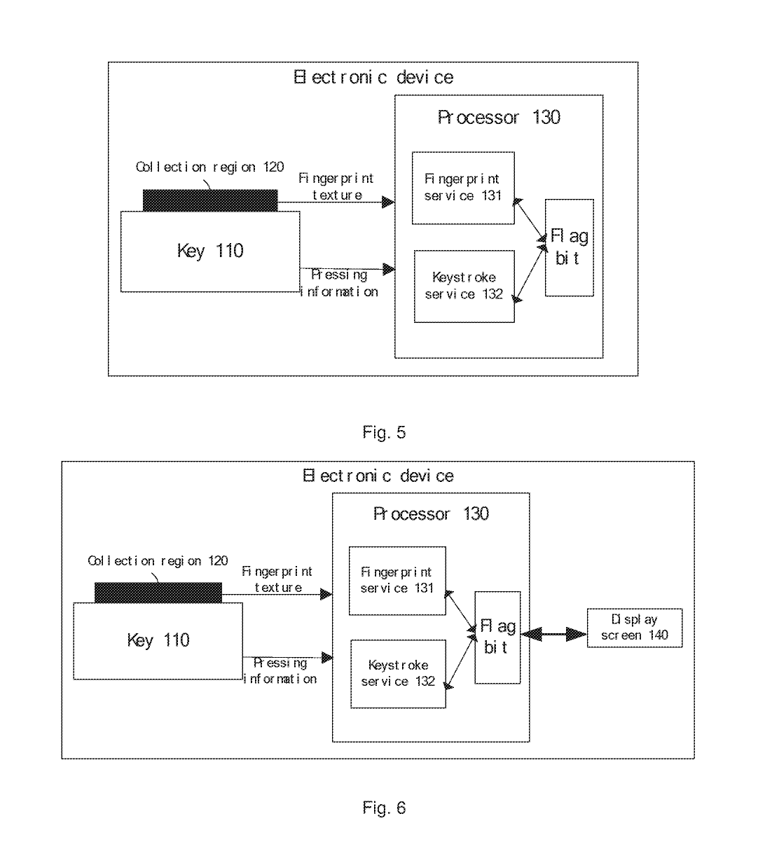

As shown in FIG. 5, the present embodiment provides an electronic device. The electronic device comprises: a key 110 configured to detect a pressing of the key, wherein a collection region 120 is provided on an input surface of the key, and the collection region 120 is configured to collect a fingerprint texture; a processor 130 configured to run a fingerprint service 131 and a keystroke service 132 of the key 110; when the electronic device enters a stage of inputting a fingerprint, the fingerprint service 131 is at a stage of verifying the fingerprint so that the fingerprint texture collected by the collection region 120 may be verified; the fingerprint service 131 is configured to set a flag bit; when the key is pressed, the keystroke service 132 is configured to obtain the flag bit and disable, based on the flag bit, responding to an operation instruction corresponding to the pressing of the key 110; when the key 110 is pressed, the collection region 120 collects the fingerprint texture, and the fingerprint service 120 is further configured to verify the fingerprint based on the fingerprint texture.

The electronic device of the present embodiment may be a mobile phone, a tablet computer, a wearable device, an electronic reader and so on. These electronic devices may be the electronic devices which run an operation system such as iOS system, Android system and the like.

The key 110 of the present embodiment may be various widgets capable of detecting the pressing. For example, the key 110 may comprise a widget which detects the pressing by its own displacement and/or detects the pressing by its own deformation or detects the pressing by detecting a pressure value. At least one surface of the key 110 is the input surface. In general, the input surface is a surface of the key 110 on the surface of the electronic device. In general, a component of the pressure force formed by the pressing in a direction perpendicular to the input surface is not equal to zero.

In particular, the key 110 may be widgets such as “enter” key, “backspace” or “home” key, power key, “direction” key and the like. The electronic device may further comprise a display screen. The display screen may be a display screen such as a Liquid Crystal display screen, an electronic ink display screen, an organic light emitting OLED display screen or a projection display screen. In general, the input surface of the key 110 and a display region of the display screen may at the same surface of the electronic device. In a common situation, the key 110 may be provided below the display region. In general, one side of the electronic device on which the display region is provided is a front surface of the electronic device; certainly, the key 110 may be provided on a side surface of the electronic device. The side surface is generally a surface which is adjacent to the front surface of the electronic device. In a particular implementation, if the key is provided on the side surface of the electronic device, the key may be provide at bottom of the electronic device to be hold by the user. The electronic device may be divided as a top portion and a bottom portion in a displaying stage of a vertical screen; and generally the user holds the electronic device at its bottom portion. The keystroke service further comprises a stage of holding, during which the key does not respond to the operation instruction corresponding to the pressing and may not implement the processing such as inputting and verifying the fingerprint. The key detects a pressure force of the pressing and transfers the pressure force to the processor, and the processor determines whether the pressure force is less than a specified pressure value; it the pressure force is less than the specified pressure force, the electronic device is controlled to be at the stage of holding. If the key is provided to be adjacent to the bottom portion of the electronic device to be hold by the user, when the user inputs the fingerprint or presses the key, the user does not needs to move fingers to the front surface of the electronic device to operate, so the user's operation is simplified. Certainly, the position to provide the key is only an example, and is not limited to the positioned as mentioned above during an actual situation.

The collection region 120 may comprise various sensors which is capable of collecting the fingerprint texture. For example, the collection region 120 may comprise a scanner or a means for collecting the fingerprint. The collection region 120 covers at least a partial region of the input surface of the key 110. The collection region 120 may fully cover the input surface of the key 110, and may partially cover the input surface of the key 110.

The processor 130 may comprise various types of processors which may be a processing chip or a processing circuit having a function of information processing, such as an application processor, a central processor, a microprocessor, a digital signal processor, a programmable array or the like.

The fingerprint service 131 and the keystroke service 132 may be run on the processor. The fingerprint service 131 may be configured to verify the fingerprint and the keystroke service 132 may be configured to the operation instruction corresponding to the detected pressing of the key.

In the present embodiment, the fingerprint service 131 and the keystroke service 132 can't precisely respond the operation to be performed currently so as to avoid conflicting with each other.

When the electronic device enters the stage of inputting the fingerprint, the fingerprint service 131 will be at the stage of verifying the fingerprint and sets the flag bit. In the present embodiment, the electronic device further comprise a storage medium, such as a register, which is configured to store the flag bit. The step of the fingerprint service 131 setting the flag bit may be writing the flag bit into a specified storage region such as a specified memory or setting the flag bit to be identification information which represents that it is at the stage of verifying the fingerprint at present.

When the key 110 is pressed, the keystroke service 132 will obtain the flag bit, e.g. read out the flag bit from the specified storage region, so as to determine whether to disable responding the operation instruction corresponding to the pressing.

When the key is pressed, the collection region 120 will in an operating stage to collect the fingerprint texture by scanning, image collection, pressure sensing and the like. Certainly, the collected fingerprint texture will be uploaded to the fingerprint service. An information transfer channel is formed between the course run by the fingerprint service and the collection region. Such an information transfer channel may be connected to the processor and a bus interface of the collector corresponding to the collection region. The fingerprint service 132 verifies the fingerprint based on the fingerprint texture and finally forms a verification result.

In the electronic device of the present embodiment, the input surface of the key 110 may be provided with the collection region 120 capable of collecting the fingerprint. Such an arrangement for overlapping the key 110 and the collection region 120 may reduce a surface area required by the electronic device to arrange the key 110 and the collection region 120 and simplify a surface structure of the electronic device. The information about the pressing as shown in FIG. 5 may comprise information which indicates whether the key 110 detects the pressing and may further comprise information about the pressure force of the pressing.

Meanwhile, in the present embodiment, the fingerprint service 131 may set the flag bit so as to avoid a false response of the key 110 and the collection 120 caused by the same pressing. The keystroke service 132 may disable responding to the operation instruction corresponding to the pressing by processing the flag bit, which may reduce the false response of the operation instruction.

It is definite that the electronic device of the present embodiment has a features of simple structure and a high intelligence.

### The Second Device Embodiment

As shown in FIG. 5, the present embodiment provides an electronic device. The electronic device comprises: a key 110 configured to detect a pressing of the key, wherein a collection region 120 is proved on an input surface of the key and the collection region 120 is configured to collect a fingerprint texture; a processor 130 configured to run a fingerprint service 131 and a keystroke service 132 of the key 110; when the electronic device enters a stage of inputting a fingerprint, the fingerprint service 131 is at a stage of verifying the fingerprint so that the fingerprint texture collected by the collection region 120 may be verified; the fingerprint service 131 is configured to set a flag bit; when the key is pressed, the keystroke service 132 is configured to obtain the flag bit and disable responding to an operation instruction corresponding to the pressing of the key 110 based on the flag bit; when the key 110 is pressed, the collection region 120 collects the fingerprint texture, and the fingerprint service 120 is further configured to verify the fingerprint based on the fingerprint texture.

When the stage of inputting the fingerprint is ended, the fingerprint service 131 removes the flag bit so that when the key 110 is pressed, the key directly responds to the operation instruction corresponding to the pressing of the key.

In the embodiment, in order for the electronic device to duly respond the operation instruction corresponding to the pressing, the flag bit is duly removed so as to responds the pressing operation corresponding to the pressing when the step of inputting the fingerprint is ended.

When the flag bit is removed, the collection of the fingerprint texture is stopped, or even the fingerprint is collected, operations such as verifying the fingerprint or triggering by a successful verification of the fingerprint.

On the basis of the previous device embodiment, the electronic device of the present embodiment further defines what time the electronic device responds the corresponding operation instruction and has an advantage of being simple and convenient.

### The Third Device Embodiment

As shown in FIG. 5, the present embodiment provides an electronic device. The electronic device comprises: a key 110 configured to detect a pressing of the key, wherein a collection region 120 is proved on an input surface of the key and the collection region 120 is configured to collect a fingerprint texture; a processor 130 configured to run a fingerprint service 131 and a keystroke service 132 of the key 110; when the electronic device enters a stage of inputting a fingerprint, the fingerprint service 131 is at a stage of verifying the fingerprint so that the fingerprint texture collected by the collection region 120 may be verified; the fingerprint service 131 is configured to set a flag bit; when the key is pressed, the keystroke service 132 is configured to obtain the flag bit and disable responding to an operation instruction corresponding to the pressing of the key 110 based on the flag bit; when the key 110 is pressed, the collection region 120 collects the fingerprint texture, and the fingerprint service 120 is further configured to verify the fingerprint based on the fingerprint texture.

The processor 130 is further configured to notify the fingerprint service 131 to verify the fingerprint when the first application or the first course required to verify the fingerprint generates a requirement for verifying the fingerprint.

The fingerprint service 131 is further configured to enter the stage of verifying the fingerprint on the basis of the notification, wherein the stage of verifying the fingerprint comprises the stage of inputting the fingerprint.

In the present embodiment, the processor 130 may further run the first application or the first course. The detailed description of the first application or the first course may be referred to the description of the corresponding method, such as an application related to a payment, an application related to processing of private information, a course for unlocking screen and the like.

In the present embodiment, when a requirement for verifying the fingerprint is generated, the first application or the first course notifies the fingerprint service to verify the fingerprint and generates a notification which may trigger the fingerprint service 132 to enter the stage of verifying the fingerprint so as to meet the requirement of verifying the fingerprint.

It is definite that in the present embodiment, when the requirement for verifying the fingerprint is generated, the first application or the first course automatically generates the notification so than the fingerprint service 132 enters the stage of verifying the fingerprint and the controller controls itself whether to enter the stage of verifying the fingerprint, which enhances the intelligence of the electronic device without the user's manual trigger and simplifies the user's operation and the user's satisfaction.

In the present embodiment, when the stage of inputting the fingerprint is ended, the fingerprint service 131 is further configured to remove the flag bit so that when the key is pressed, the key directly responds to the operation instruction corresponding to the pressing of the key. Certainly, in the present embodiment, the fingerprint service may not remove the flag bit when the stage of inputting the fingerprint is ended.

### The Fourth Device Embodiment

As shown in FIG. 5, the present embodiment provides an electronic device. The electronic device comprises: a key 110 configured to detect a pressing of the key, wherein a collection region 120 is proved on an input surface of the key and the collection region 120 is configured to collect a fingerprint texture; a processor 130 configured to run a fingerprint service 131 and a keystroke service 132 of the key 110; when the electronic device enters a stage of inputting a fingerprint, the fingerprint service 131 is at a stage of verifying the fingerprint so that the fingerprint texture collected by the collection region 120 may be verified; the fingerprint service 131 is configured to set a flag bit; when the key is pressed, the keystroke service 132 is configured to obtain the flag bit and disable responding to an operation instruction corresponding to the pressing of the key 110 based on the flag bit; when the key 110 is pressed, the collection region 120 collects the fingerprint texture, and the fingerprint service 120 is further configured to verify the fingerprint based on the fingerprint texture.

The first application or the first course is configured to generate an interface for indicating to input the fingerprint when a requirement of verifying the fingerprint is generated; or the fingerprint service 131 is further configured to generate the interface for indicating to input the fingerprint.

As shown in FIG. 6, the electronic device further comprises a display screen 140 configured to display the interface for indicating to input the fingerprint so as to indicate the user of the electronic device to input the fingerprint.

The display screen 140 of the present embodiment may be one of the display screens such as a Liquid Crystal display screen, an electronic ink display screen, an OLED display screen illustrated in the first device embodiment. In the present embodiment, a signal transfer channel is formed between the display screen and the processor, and the signal transfer channel may comprise structures such as an internal bus.

In the present embodiment, the first application or the first course will generate the interface for indicating to input the fingerprint and the interface for indicating to input the fingerprint will be displayed by the display screen.

The user is indicated to input the fingerprint by the interface for indicating to input the fingerprint, or the user is notified that it is at the stage of verifying the fingerprint and a fingerprint can be input.

By providing the interface for indicating to input the fingerprint, information about that the fingerprint can be input or the fingerprint needs to be input is delivered to the user, which enhances information communication with the user and improves the electronic device's intelligence and the user's satisfaction.

### The Fifth Device Embodiment

As shown in FIG. 5, the present embodiment provides an electronic device. The electronic device comprises: a key 110 configured to detect a pressing of the key, wherein a collection region 120 is proved on an input surface of the key and the collection region 120 is configured to collect a fingerprint texture; a processor 130 configured to run a fingerprint service 131 and a keystroke service 132 of the key 110; when the electronic device enters a stage of inputting a fingerprint, the fingerprint service 131 is at a stage of verifying the fingerprint so that the fingerprint texture collected by the collection region 120 may be verified; the fingerprint service 131 is configured to set a flag bit; when the key is pressed, the keystroke service 132 is configured to obtain the flag bit and disable responding to an operation instruction corresponding to the pressing of the key 110 based on the flag bit; when the key 110 is pressed, the collection region 120 collects the fingerprint texture, and the fingerprint service 120 is further configured to verify the fingerprint based on the fingerprint texture.

When the keystroke service 132 obtains the flag bit, the keystroke service is further configured to generate an indication information for indicating the user whether to leave the stage of verifying fingerprint; the keystroke service is configured to obtain a first confirmation instruction for representing that the user selects to leave the stage of verifying the fingerprint; the keystroke service is configured to remove the flag bit in response to the first confirmation instruction so that when the key is pressed, the key directly responds to the operation instruction corresponding to the pressing of the key.

In the present embodiment, after the keystroke service 132 obtains the flag bit, the keystroke service generates the indicating information for indicating the user whether to exit the stage of verifying the fingerprint. The first confirmation instruction is a user instruction formed on the basis of the indicating information.

The keystroke service 132 will respond the first confirmation instruction to exit the stage of verifying the fingerprint. Thus, the electronic device will maintain a stage of responding the operation instruction corresponding to the detected pressing of the key.

The indicating information may be a dialog box or may be information content such as dialog message.

As shown in FIG. 6, when the processor is capable of running the first application or the first course required to verify the fingerprint to generate a requirement of verification, the interface for indicating to input the fingerprint is generated and displayed on the display screen of the electronic device so as to indicate the user of the electronic device to input the fingerprint. When the interface for indicating to input the fingerprint is displayed on the display screen, the indicating information may comprise indicating information for selecting to exit the interface for inputting the fingerprint. If the indicating information is the indicating information for selecting to exit the interface for inputting the fingerprint, the keystroke service 132 will remove the flag bit after receiving the instruction formed on the basis of the indicating information. Consequently, the fingerprint service 131 exit the stage of verifying the fingerprint, and the keystroke service 132 releases the disabling of responding the operation instruction corresponding to the pressing.

The electronic device of the present embodiment may provides an entrance for the user to exit the stage of verifying the fingerprint by outputting the indicating information after entering the stage of verifying the fingerprint, which further enhances the intelligence of the electronic device and the user's satisfaction.

In conjunction with the embodiments as mentioned above, some particular examples are provided as follows.

### The First Example

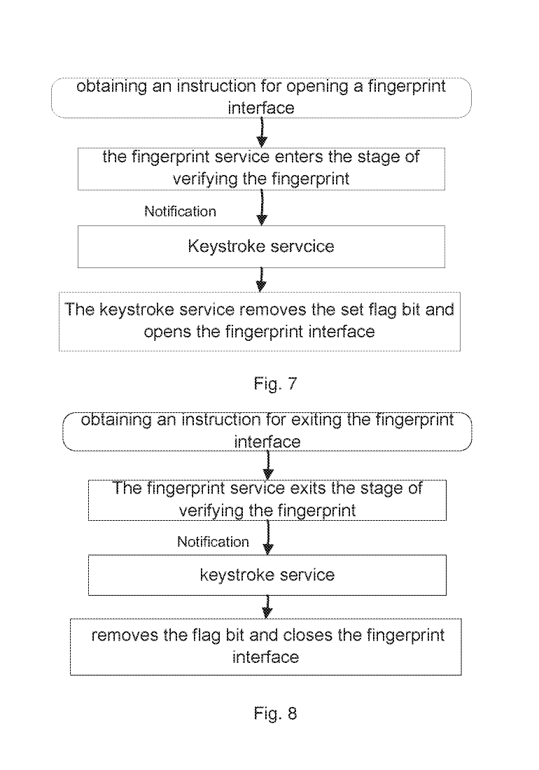

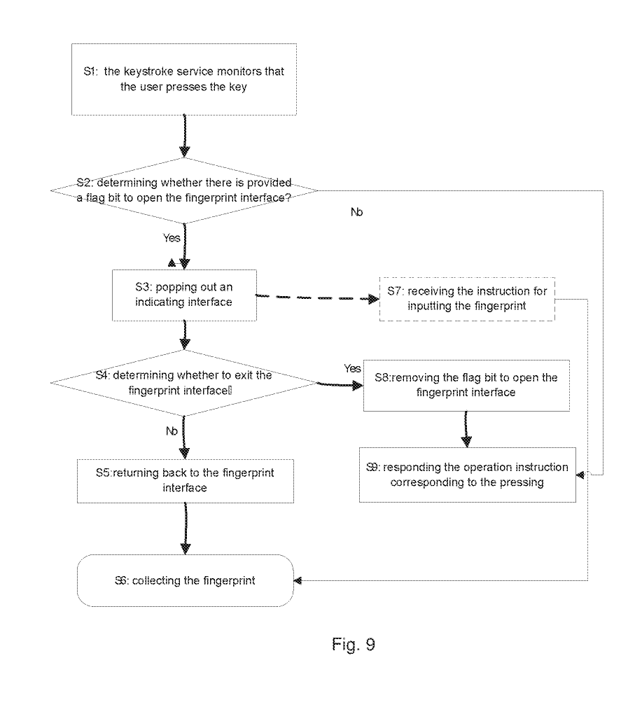

As shown in FIG. 7, the present example provides a process for entering a fingerprint interface, which comprises: obtaining an instruction for opening a fingerprint interface. Herein, the fingerprint interface may be an interface for inputting the fingerprint and may indicate to input the fingerprint, which corresponds to the interface for indicating to input the fingerprint. The instruction for indicating to input the fingerprint may be sent by the first application or the first course, and may be formed on the basis of the user's instruction.

Then, the fingerprint service enters the stage of verifying the fingerprint.

The fingerprint service notifies the keystroke service. For example, the fingerprint service notifies the keystroke service that it has entered the stage of verifying the fingerprint.

The keystroke service removes the set flag bit and opens the fingerprint interface.

### The Second Example

As shown in FIG. 8, the present example provides a process for exiting the fingerprint interface, which comprises: obtaining an instruction for exiting the fingerprint interface. Herein, the fingerprint interface may be an interface for inputting the fingerprint as mentioned above. The instruction for exiting the fingerprint interface may be the first confirmation instruction in the previous embodiments.

The fingerprint service exits the stage of verifying the fingerprint.

The fingerprint service notifies the keystroke service. For example, the fingerprint service notifies the keystroke service that it has exited the stage of verifying the fingerprint.

The keystroke service removes the flag bit and closes the fingerprint interface.

### The Third Example

The present example provides an information processing method, which comprises the following steps:

At a step of S1, the keystroke service monitors that the user presses the key.

At a step of S2, determining whether there is provided a flag bit to open the fingerprint interface? If it is, it turns to a step of S3; otherwise, it turns to a step of S9. The fingerprint interface may be an interface for inputting the fingerprint and may correspond to the finger in the previous embodiment.

At a step of S3, popping out an indicating interface for indicating to input the fingerprint. After the step of S3, it may turn to a step of S4 or a step of S7.

At the step of S4, determining whether to exit the fingerprint interface. If it is so, it returns to a step of S8; otherwise, it returns to a step of S5. Herein, the electronic device may display the indicating information by the indicating interface, and receive a reply instruction returned on the basis of the indicating information to determine the next step.

At the step of S5, returning back to the fingerprint interface.

At the step of S6, collecting the fingerprint.

At the step of S7, receiving the instruction for inputting the fingerprint. In general, the instruction may be passively received by the electronic device, for example, the instruction actively input by the user utilizing a voice input or manually inputting.

At the step of S8, removing the flag bit to open the fingerprint interface.

At the step of S9, responding the operation instruction corresponding to the pressing.

In several embodiments of the present application, it should be understood that the disclosed device and method may be implemented by other means. The device embodiment as mentioned above is only illustrative. For example, the dividing of units is only a logical division and may be further divided differently. For example, the plurality of units and components can be combined or integrated into another system; some features can be omitted or are not performed. Furthermore, the coupling among the respective components, the direct coupling or the communication coupling may be done through some interfaces; and the indirect coupling or communication connection among the devices or units may be electrical, mechanical or other connections.

The user illustrated as a separated units as mentioned above may be or may not be physically separated. And the component displayed as a unit may be or may not be a physical unit, and may be at one position and may be distributed over a plurality of network units. A portion of or all of the units may be selected according to actual requirements.

Moreover, the respective functional units of the respective embodiments of the present disclosure can be integrated into one processing unit, or each of the respective units functions as one unit, or two or more units are integrated into one unit. The integrated units as mentioned above can be implemented in hardware or in hardware plus functional units of software.

It should be understood by those skilled in the art that all of or a portion of the steps of the method embodiments can be done by hardware related to program instructions. The program as mentioned above can be stored in one computer readable storage medium. Being executed, the program performs the steps of the method embodiments. The storage medium may comprise various medium capable of storing the program code such as mobile storage device, a read-only memory (ROM), a random access memory (RAM), a magnetic disk or an optical disk.

The contents as mentioned above are only particular embodiments of the present disclosure, and the scope of the present disclosure is not limited thereto. While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims as attached.

I/We claim:

1. An information processing method, comprising:
a fingerprint service entering a stage of verifying the fingerprint, when an electronic device enters a stage of inputting a fingerprint, so that a fingerprint texture, which collected by a collecting region in an input surface of a key of the electronic device, is capable of being verified;
the fingerprint service setting a flag bit;
a keystroke service obtaining the flag bit when the key is pressed;
disabling, based on the flag bit, a corresponding operation instruction by the keystroke service in response to the pressing of the key;
collecting the fingerprint texture by the collection region in the input surface of the key when the key is pressed, and the fingerprint service verifying the fingerprint based on the fingerprint texture.

2. The method according to claim 1, further comprising:
the fingerprint service removing the flag bit when the stage of inputting a fingerprint is ended, so that the key directly responds to the operation instruction corresponding to the pressing of the key.

3. The method according to claim 1, wherein the step of the electronic device entering the stage of inputting a fingerprint comprises: notifying the fingerprint service of verify the fingerprint when a first application or a first progress required to verify the fingerprint generates a verification requirement; and
the fingerprint service entering the stage of verifying the fingerprint based on the notifying, wherein the stage of verifying the fingerprint comprises the stage of inputting the fingerprint.

4. The method according to claim 3, further comprising:
generating an interface for indicating to input the fingerprint and displaying the interface on a display screen of the electronic device to prompt a user of the electronic device to input the fingerprint, when the first application or the first progress required to verify the fingerprint generates the verification requirement; or
generating the interface for indicating to input the fingerprint the fingerprint service, and displaying the interface on the display screen of the electronic device to prompt a user of the electronic device to input the fingerprint.

5. The method according to claim 1, further comprising:
generating, by the keystroke service, an indication information for indicating the user whether to leave the stage of verifying fingerprint, When the keystroke service obtains the flag bit;
obtaining, by the keystroke service, a first confirmation instruction for representing that the user selects to leave the stage of verifying the fingerprint;
removing the flag bit by the keystroke service, in response to the first confirmation instruction so that the key directly responds to the operation instruction corresponding to the pressing of the key.

6. An electronic device, comprising:
a key configured to detect a pressing of the key, wherein a collection region is provided in an input surface of the key, and the collection region is configured to collect a fingerprint texture;
a processor configured to run a fingerprint service and a keystroke service; when the electronic device enters a stage of inputting a fingerprint, the fingerprint service is at a stage of verifying the fingerprint so that a fingerprint texture collected by the collecting region is capable of being verified;
the fingerprint service configured to set a flag bit;
the keystroke service obtains the flag bit when the key is pressed, and disables, based on the flag bit, a corresponding operation instruction in response to the pressing of the key;
when the key is pressed, the fingerprint texture is collected by the collection region; and
the fingerprint service is further configured to verify the fingerprint based on the fingerprint texture.

7. The electronic device according to claim 6, wherein the fingerprint service removes the flag bit when the stage of inputting a fingerprint is ended, so that the key directly responds to the operation instruction corresponding to the pressing of the key.

8. The electronic device according to claim 6, wherein
the processor is further configured to run a first application or a first progress required to verify the fingerprint;
the first application or the first progress generates the requirement of verifying and notifies the fingerprint service to verify the fingerprint; and
the fingerprint service enters the stage of verifying the fingerprint based on the notifying, wherein the stage of verifying the fingerprint comprises the stage of tying in the fingerprint.

9. The electronic device according to claim 8, wherein the first application or the first progress is further configured to generate an interface for indicating to input the fingerprint when a requirement of verifying the fingerprint is generated, or the fingerprint service is further configured to generate an interface for indicating to input the fingerprint;
the electronic device further comprises a display screen for displaying the interface for indicating to input the fingerprint so as to prompt the user of the electronic device to input the fingerprint.

10. The electronic device according to claim 6, wherein the keystroke service is further configured to generate an indication information for indicating the user whether to leave the stage of verifying fingerprint when the flag bit is obtained; the keystroke service obtains a first confirmation instruction for representing that the user selects to leave the stage of verifying the fingerprint; the keystroke service removes the flag bit in response to the first confirmation instruction so that when the key is pressed, the key directly responds to the operation instruction corresponding to the pressing of the key.
